(19) United States
(12) Patent Application Publication
(10) Pub. No.: US 2026/0113734 A1
(43) Pub. Date: Apr. 23, 2026

(54) CARRIER SELECTION IN SIDELINK COMMUNICATION

(71) Applicant: TOYOTA JIDOSHA KABUSHIKI KAISHA, Toyota-shi, Aichi-ken (JP)

(72) Inventors: Takayuki SHIMIZU, Mountain View, CA (US); Claude ARZELIER, Varna (BG); Kai-Erik SUNELL, Naantali (FI); Daniel MEDINA, Munchen (DE); Nuno KIILERICH PRATAS, Gistrup (DK); Berthold PANZNER, Holzkirchen (DE); Renato BARBOSA ABREU, Aalborg (DK); Thomas JACOBSEN, Noerresundby (DK); Torsten WILDSCHEK, Gloucester (GB)

(73) Assignee: TOYOTA JIDOSHA KABUSHIKI KAISHA, Toyota-shi, Aichi-ken (JP)

(21) Appl. No.: 19/117,052

(22) PCT Filed: Sep. 15, 2023
(86) PCT No.: PCT/JP2023/033683

§ 371 Date: Mar. 30, 2025

Related U.S. Application Data
(60) Provisional application No. 63/377,570, filed on Sep. 29, 2022.

(51) Int. Cl. H04W 72/02; H04L 5/00; H04W 72/0453; H04W 72/40

(52) U.S. Cl. CPC H04W 72/02; H04L 5/0053; H04W 72/0453; H04W 72/40

(57) ABSTRACT

Disclosed are methods, apparatuses, and systems for carrier selection or re-selection for sidelink carrier aggregation. The methods include: determining, by a user equipment (UE) in a first sidelink communication, based on a first condition, one or more first candidate carriers from among one or more dedicated sidelink carriers, the one or more dedicated sidelink carriers being dedicated for the first sidelink communication; determining, by the UE, based on a second condition, one or more second candidate carriers from among one or more shared sidelink carriers, the one or more shared sidelink carriers being shared by at least the first sidelink communication and a second sidelink communication; and selecting, by the UE, one or more sidelink carriers for a sidelink transmission from among at least one of: the one or more first candidate carriers or the one or more second candidate carriers.

### CROSS-REFERENCE TO RELATED PATENT APPLICATION

This application claims the benefit of U.S. Provisional Application No. 63/377, 570, filed on Sep. 29, 2022, entitled “CARRIER SELECTION IN SIDELINK COMMUNICATION,” the entirety of which is incorporated by reference herein.

### TECHNICAL FIELD

Apparatuses and methods consistent with the present disclosure relate generally to communications, more specifically, methods, systems, and devices for carrier selection or reselection in sidelink communications for carrier aggregation.

### BACKGROUND ART

Carrier aggregation of multiple sidelink carriers may allow for increased throughput and/or improved reliability of sidelink communications. When a first user equipment (UE) in a first sidelink communication is able to use both dedicated sidelink carriers dedicated for the first sidelink communication only, and shared sidelink carriers shared by the first sidelink communication and a second sidelink communication, the first UE may prefer to aggregate one or more carriers from the dedicated sidelink carriers and one or more carriers from the shared sidelink carriers to achieve increased throughput and/or reliability. However, the use of the shared sidelink carriers by the first UE may negatively impact a second UE in the second sidelink communication because the second UE in the second sidelink communication may not be able to detect the selection of the shared sidelink carriers by the first UE. This is especially the case when the second UE in the second sidelink communication does not have a module to detect or decode the resource reservation information in the first sidelink communication. In addition, the use of the shared sidelink carriers by the first UE may cause congestion in the shared sidelink carriers. Thus, proper selection or reselection of carriers from the dedicated sidelink carriers and the shared sidelink carriers for carrier aggregation is helpful in improving fairness in resource allocation and achieving high efficiency and throughput in sidelink communications.

The resource selection procedure of 3rd Generation Partnership Project (3GPP) Release 16/17 5G New Radio (NR) vehicle-to-everything (V2X) PC5 mode 2 is specified in 3GPP Technical Specification (TS) 38.213, TS 38.214, and TS 38.321. For resource selection, a UE performs channel sensing in a sensing window and collects another UE's resource reservation information based on sidelink control information (SCI) decoding to identify candidate resources in a selection window T (T=[T₁, T₂]). First, the UE excludes some time slots from the selection window due to unmonitored resources in the sensing window that the UE cannot sense due to its own transmission (i.e., half-duplex constraint). Then, the UE further excludes resources reserved by other UEs from the selection window if the corresponding sidelink-reference signal received power (SL-RSRP) exceeds the (pre-) configured SL-RSRP exclusion threshold. After resource exclusion, the number of candidate resources shall be at least X % of the total number of resources in the selection window. Otherwise, UE increases SL-RSRP exclusion threshold by 3 dB until obtaining at least X % resources, where X is (pre-) configured from {20, 35, 50} %. Finally, the UE randomly selects resources among candidate resources in the selection window. The Selected frequency resource can be used for multiple times with a fixed time interval for subsequent transmissions (i.e., semi-persistent scheduling (SPS) ) or only once (i.e., one-shot transmission (OST) ). Also, the UE can retransmit packets multiple times (i.e., hybrid automatic repeat request (HARQ) retransmissions) with or without feedback from receiver UEs to improve the reliability.

In order for a UE to perform sensing and obtain information to receive other UEs'packets, the UE decodes SCI first. In Release 16, there are 1^{st}-stage SCI (SCI format 1-A) and 2^{nd}-stage SCI (SCI format 2-A or 2-B) as defined in 3GPP TS 38.212. 1^{st}-stage SCI carries resource reservation information for future transmissions, as well as information about resource allocation and modulation and coding scheme (MCS) for physical sidelink shared channel (PSSCH), demodulation reference signal (DMRS) pattern, 2^{nd}-stage SCI format, etc. 2^{nd}-stage SCI carries control information for HARQ procedures, source/destination IDs, information for distance-based groupcast (UE's zone identification (ID) and communication range requirement), etc.

Based on the resource reservation contained in 1^{st}-stage SCI, each UE avoids using time/frequency resources reserved by other UEs when it performs resource (re-) selection.

In Release 17 5G NR-V2X PC5 mode 2, inter-UE coordination (IUC) is introduced, in which a first UE (UE-A) sends coordination information about resources to a second UE (UE-B), and the UE-B utilizes that information for its resource (re-)selection. The following two schemes of inter-UE coordination are supported:
IUC scheme 1: A UE-A can provide to a UE-B indications of resources that are preferred to be included in the UE-B's (re-)selected resources, or preferred to be excluded. When given resources to include, the UE-B may rely only on those resources, at least if it does not support sensing/resource exclusion, or the UE-B may combine them with resources identified by its own sensing procedure, before making a final selection. The indication from the UE-A to the UE-B is sent in medium access control (MAC) control element (CE) and/or 2^{nd}-stage SCI.
IUC scheme 2: A UE-A can provide to a UE-B an indication that resources reserved for UE-B's transmission (which may or may not be to the UE-A) will be, or could be, subject to conflict with a transmission from another UE. Then, the UE-B re-selects new resources to replace them. The indication from the UE-A to the UE-B is sent in a physical sidelink feedback channel (PSFCH).

### SUMMARY OF INVENTION

According to some embodiments of the present disclosure, there is provided a method for carrier selection or re-selection for sidelink carrier aggregation. The method includes determining, by a UE in a first sidelink communication, based on a first condition, one or more first candidate carriers from among one or more dedicated sidelink carriers, the one or more dedicated sidelink carriers being dedicated for the first sidelink communication; determining, by the UE, based on a second condition, one or more second candidate carriers from among one or more shared sidelink carriers, the one or more shared sidelink carriers being shared by at least the first sidelink communication and a second sidelink communication; and selecting, by the UE, one or more sidelink carriers for a sidelink transmission from among at least one of: the one or more first candidate carriers or the one or more second candidate carriers.

According to some embodiments of the present disclosure, there is provided a UE. The UE includes a memory storing an instruction; and a processor configured to execute the instruction stored in the memory to: determine, based on a first condition, one or more first candidate carriers from among one or more dedicated sidelink carriers, the one or more dedicated sidelink carriers being dedicated for the first sidelink communication; determine, based on a second condition, one or more second candidate carriers from among one or more shared sidelink carriers, the one or more shared sidelink carriers being shared by at least the first sidelink communication and a second sidelink communication; and select one or more sidelink carriers for a sidelink transmission from among at least one of: the one or more first candidate carriers or the one or more second candidate carriers.

According to some embodiments of the present disclosure, there is provided a non-transitory computer-readable medium storing instructions that are executable by one or more processors of a UE to perform a method. The method includes determining, based on a first condition, one or more first candidate carriers from among one or more dedicated sidelink carriers, the one or more dedicated sidelink carriers being dedicated for the first sidelink communication; determining, based on a second condition, one or more second candidate carriers from among one or more shared sidelink carriers, the one or more shared sidelink carriers being shared by at least the first sidelink communication and a second sidelink communication; and selecting one or more sidelink carriers for a sidelink transmission from among at least one of: the one or more first candidate carriers or the one or more second candidate carriers.

### BRIEF DESCRIPTION OF DRAWINGS

FIG. 1 is a flow chart illustrating a method for resource selection in a sidelink communication, consistent with some embodiments of the present disclosure.

FIG. 2 is a schematic diagram illustrating a resource candidate determination procedure according to the method of FIG. 1, consistent with some embodiments of the present disclosure.

FIG. 3 is a flow chart illustrating a method for resource selection in a sidelink communication, consistent with some embodiments of the present disclosure.

FIG. 4A is a schematic diagram illustrating a resource candidate determination procedure according to the method of FIG. 3, consistent with some embodiments of the present disclosure.

FIG. 4B is a table showing a correspondence between sub-carrier spacing (SCS) and a subset of resources according to the method of FIG. 3, consistent with some embodiments of the present disclosure.

FIG. 5 is a schematic diagram illustrating dynamic co-channel coexistence of a first sidelink (SL) communication and a second sidelink (SL) communication, consistent with some embodiments of the present disclosure.

FIG. 6 is a schematic diagram illustrating device types for dynamic co-channel coexistence of a first sidelink (SL) communication and a second sidelink (SL) communication, consistent with some embodiments of the present disclosure.

FIG. 7 is a schematic diagram illustrating an exemplary sidelink carrier aggregation using one or more sidelink carriers dedicated for a first sidelink communication only, and one or more sidelink carriers shared by the first sidelink communication and a second sidelink communication, consistent with some embodiments of the present disclosure.

FIG. 8 is a flow chart illustrating a method for carrier selection or re-selection for sidelink carrier aggregation, consistent with some embodiments of the present disclosure.

FIG. 9 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

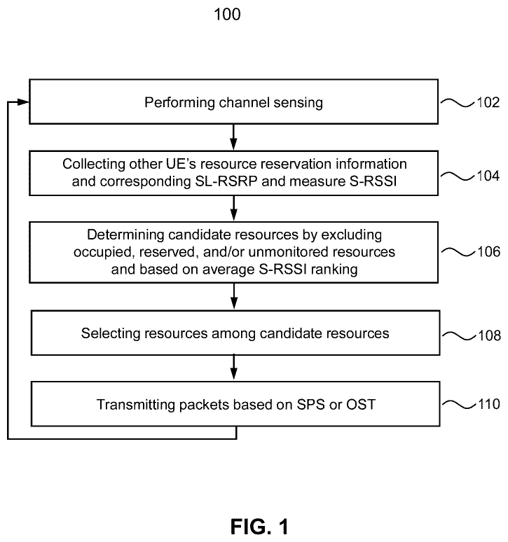

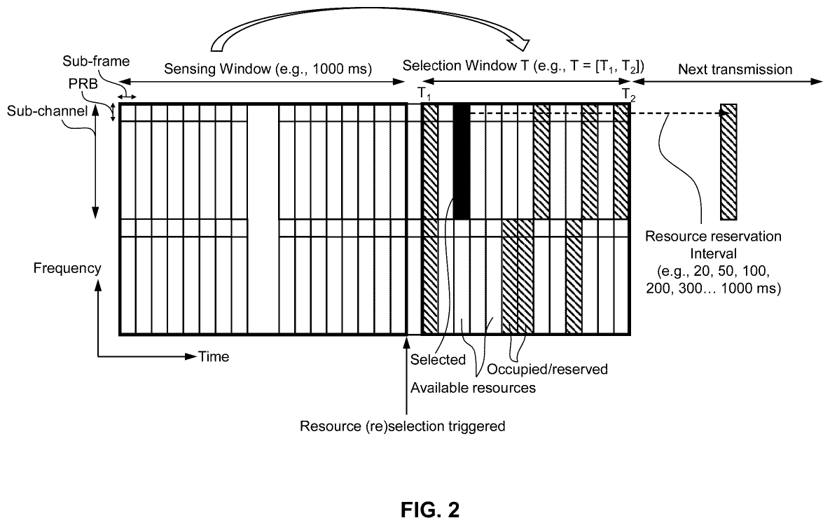

FIG. 1 is a flow chart illustrating a method 100 (referred to as the “first method” in this disclosure) for resource selection in a sidelink communication; and FIG. 2 is a schematic diagram illustrating a resource candidate determination procedure according to the first method, consistent with some embodiments of the present disclosure. The method 100 may be performed by a UE in a sidelink communication. For example, the method 100 may be performed by a vehicle in a V2X communication. The method 100 may be performed under a mode (referred to as the “first mode” in this disclosure) that employs discrete Fourier transform spread orthogonal frequency division multiplexing (DFT-s-OFDM) for sidelink at the physical (PHY) layer. An example of the first mode is the 3GPP Release 14/15 Long-Term Evolution (LTE) V2X PC5 mode 4.

As shown in FIG. 2, in the first mode, the time-frequency radio resources are divided into sub-frames in the time domain and sub-channels in the frequency domain. In an embodiment, the first mode may only support 15 kHz sub-carrier spacing. Each sub-frame may be 1 ms length and may consist of 14 DFT-s-OFDM symbols. Each sub-channel may consist of multiple contiguous physical resource blocks (PRBs), where each PRB occupies 180 kHz and consists of 12 subcarriers with 15 kHz SCS. The size of sub-channel (i.e., the number of PRBs per sub-channel) may be configurable or preconfigurable. To cope with high Doppler caused by high relative speed in vehicular scenarios, the density of demodulation reference signal (DMRS), which is used for frequency offset compensation and channel estimation, may be set to four per sub-frame. Each UE may broadcast data (e.g., transport block (TB)) in the PSSCH and SCI in the physical sidelink control channel (PSCCH). The PSCCH may occupy two contiguous PRBs. The number of PRBs for PSSCH may be configurable or preconfigurable. The SCI format may contain information to decode the corresponding TB in PSSCH and facilitate UE autonomous resource selection. As shown in FIG. 2, the resource reservation interval can be set to one of the allowed values (e.g., 20, 50, 100, 200, 300 . . . 1000 ms).

PSCCH and the corresponding PSSCH may be transmitted in the same sub-frame in either adjacent or non-adjacent PRBs in the frequency domain.

Referring to FIG. 1, method 100 includes a step 102 of performing a channel sensing (e.g., background sensing or any other type of full sensing or partial sensing). For example, as shown in FIG. 2, for resource selection, a UE may perform a channel sensing in a sensing window (e.g., 1000 ms) to collect another UE's resource reservation information. The sensing window can be any time duration, depending on the UE implementation.

Referring back to FIG. 1, the method 100 includes a step 104 of collecting another UE's resource reservation information and corresponding SL-RSRP, and measuring sidelink received signal strength indicator (S-RSSI). For example, the UE may collect resource reservation information of other UEs and the corresponding SL-RSRPs. The UE may also measure the S-RSSI using received sidelink signals. The UE may decode received SCI included in the received sidelink signals to identify candidate resources in a selection window T (e.g., T=[T₁, T₂], where T₁=4 ms, and 20≤T₂=100 ms), as shown in FIG. 2. The selection of the T₁ and T₂ values depends on the UE implementation.

The method 100 includes a step 106 of determining candidate resources by excluding occupied, reserved, and/or unmonitored resources and based on an average S-RSSI ranking. For example, as shown in FIG. 2, once the resource selection or reselection is triggered, the UE may exclude some sub-frames from the selection window. The excluded sub-frames may be the resources not monitored in the sensing window. The UE may not sense these resources due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least 20% of the total number; of resources in the selection window. Otherwise, the UE may increase the SL-RSRP exclusion threshold by, for example, 3 dB until the candidate resources reaches at least 20% of the total resources. The UE may further calculate the corresponding S-RSSI of each sub-channel resource as a linear average over the S-RSSIs of the monitored resources with a certain interval (e.g., the averaging interval is 100 ms for a resource reservation interval of greater than or equal to 100 ms). The UE may determine, for example, 20% best resources in terms of lowest average S-RSSI as the candidate resources among the total resources in the selection window. The UE may use the 20% resources with the lowest average S-RSSI based on S-RSSI ranking as candidate resources.

The method 100 includes a step 108 of selecting resources among candidate resources. The selection of the resources among the candidate resources may be a random selection. For example, as shown in FIG. 2, the UE may select a single-subframe resource in a uniformly random manner among candidate single-subframe resources. The selected frequency resource can be used for multiple times with a fixed time interval for subsequent transmissions (this scheme is referred to as SPS in this disclosure) or only once (this scheme is referred to as OST in this disclosure).

The method 100 includes a step 110 of transmitting packets based on SPS or OST. The packets can be initial or retransmitted packets. For example, the UE may transmit an initial packet using the selected resources. For another example, the UE may retransmit a packet up to one time without feedback from receiver UEs to improve reliability of the transmission (this is referred to as “blind HARQ retransmission” in 3GPP and this disclosure). After the transmission, the method may start again from the step 102.

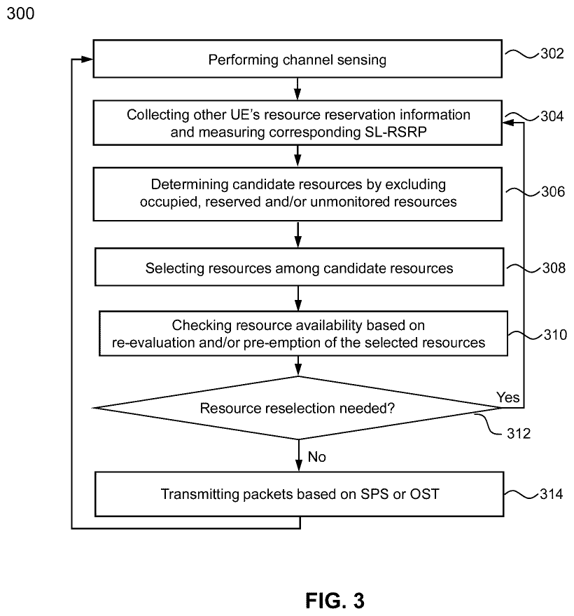

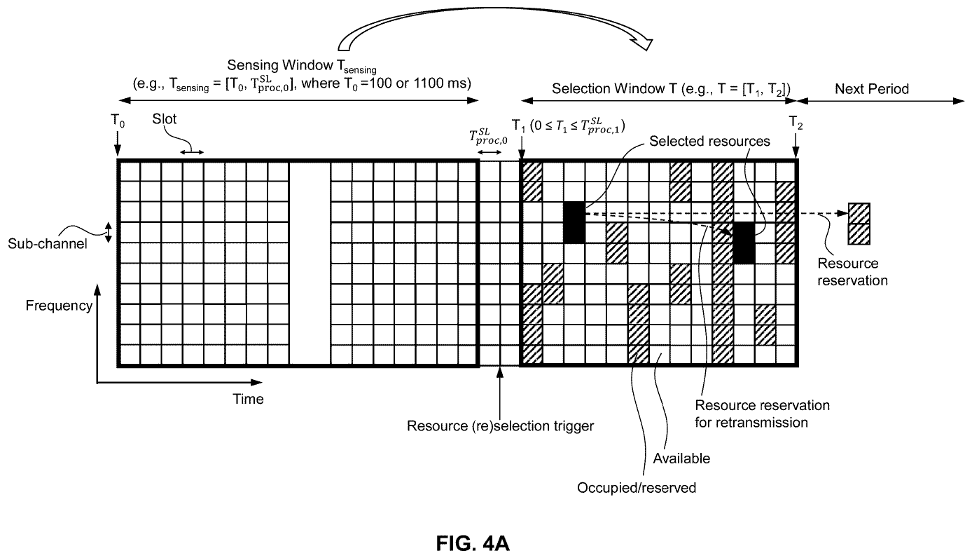

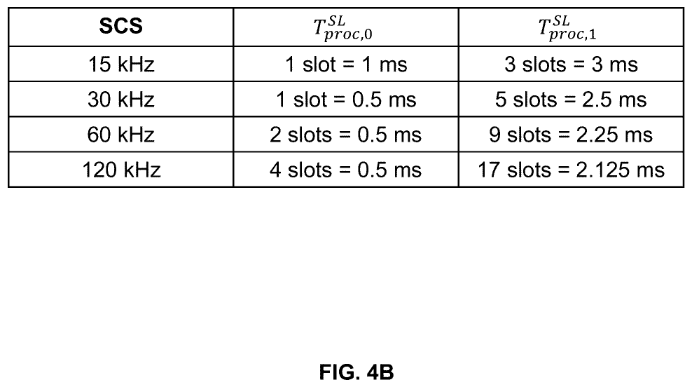

FIG. 3 is a flow chart illustrating a method 300 (referred to as the “second method” in this disclosure) for resource selection in a sidelink communication; FIG. 4A is a schematic diagram illustrating a resource candidate determination procedure according to the second method; and FIG. 4B is a table showing a correspondence between SCS and a subset of resources according to the second method, consistent with some embodiments of the present disclosure. The method 300 may be performed by a UE in a sidelink communication. For example, the method 300 may be performed by a vehicle in a V2X communication. The method 300 may be performed under a mode (referred to as the “second mode” in this disclosure) that employs orthogonal frequency division multiplexing (OFDM) at the PHY layer for a sidelink communication. An example of the second mode is the 3GPP Release 16/17 5G NR-V2X PC5 mode 2.

As shown in FIG. 4A, in the second mode, the time-frequency radio resources are divided into slots in the time domain and sub-channels in the frequency domain. In an embodiment, the second mode may support SCSs of 15·2-kHz, where u is the OFDM numerology μ∈{0, 1, 2, 3, 4}. For sub-6 GHZ frequency, SCSs of 15, 30, and 60 KHz (i.e., μ∈{0, 1, 2} ) may be supported, whereas for above 6 GHz frequency, SCSs of 60, 120, and 240 kHz (i.e., μ∈{2, 3, 4}) may be supported. Each slot is 1/2^{μ} ms length and consists of 14 OFDM symbols. Each sub-channel may consist of multiple contiguous PRBs, where each PRB occupies 180·2^{μ} H kHz and consists of 12 subcarriers with 15·2^{μ} H KHZ SCS. The size of sub-channel (i.e., the number of PRBs per sub-channel) is configurable or preconfigurable. To support multiple SCSs and different Doppler spreads, multiple DMRS density options (2˜4 DMRS symbols per slot) are supported. Each UE may transmit a first stage SCI in the PSCCH and data (e.g., TB), and a second stage SCI in the PSSCH. HARQ feedback (e.g., acknowledgement (ACK)/negative acknowledgement (NACK) or NACK only) may be transmitted in the PSFCH.

FIG. 4B shows the correspondence among SCS and parameters for the sensing window and selection window (T^{SL}_{proc,0} and T^{SL}_{proc,1}), consistent with some embodiments of the present disclosure. For example, when the SCS is 15 kHz, as shown in the second and third columns of FIG. 4B, T^{SL}_{proc,0} corresponds to 1 ms, and T^{SL}_{proc,1} correspond to 3 ms. As another example, when the SCS is 30 kHz, T^{SL}_{proc,0} corresponds to 0.5 ms, and T^{SL}_{proc,1} correspond 2.5 ms.

Referring back to FIG. 3, the method 300 includes a step 302 of performing a channel sensing (e.g., a background sensing or any other type of full sensing or partial sensing). For example, as shown in FIG. 4A, a UE may perform a channel sensing in a sensing window T_{sensing} (e.g., T_{sensing}=[T₀, T^{SL}_{proc,0}], where T₀=100 or 1100 ms and T^{SL}_{proc,0} is given in FIG. 4B) to collect another UE's resource reservation information. The channel sensing with a sensing window of 100 ms may be for an aperiodic traffic, while the channel sensing with a sensing window of 1100 ms may be for a periodic traffic.

The method 300 includes a step 304 of collecting another UE's resource reservation information and measuring corresponding SL-RSRPs. For example, as shown in FIG. 4A, the UE may perform a channel sensing in the sensing window and collect another UE's resource reservation information based on SCI decoding to identify candidate resources. In an embodiment, in order to perform the channel sensing and obtain information to receive other UEs'packets, the UE decodes SCI first. The SCI decoding may include two stages: a first stage SCI (SCI format 1-A) and a second stage SCI (SCI format 2-A or 2-B) as defined in 3GPP specifications. The first stage SCI may carry resource reservation information for future transmissions, information about resource allocation, MCS for PSSCH, DMRS pattern, and the second stage SCI format, etc. The second stage SCI may carry control information for HARQ procedures, source/destination IDs, information for distance-based groupcast (e.g., UE's zone ID and communication range requirement), etc. Based on the resource reservation information contained in the first stage SCI, the UE may avoid using time and/or frequency resources reserved by other UEs when the UE performs resource selection or reselection.

The method 300 may support inter-UE coordination in which a first UE (UE-A) sends coordination information about resources to a second UE (UE-B), and the UE-B utilizes that information for its resource selection or reselection. In some embodiments, the UE may support a first inter-UE coordination scheme. In the first inter-UE coordination scheme, the UE may receive from another UE indications of resources that are preferred to be included in the UE's selected or reselected resources, or preferred to be excluded. In an embodiment, when an indication of resources indicates inclusion of given resources, the UE may solely rely on those resources, if the indication does not support sensing and/or resource exclusion. In an embodiment, the UE may also combine the indication of resources with resources identified by its own sensing procedure before making a final selection. The UE may receive the indication via MAC CE and/or 2nd-stage SCI. In some embodiments, the UE may support a second inter-UE coordination scheme. In the second inter-UE coordination scheme, the UE may receive an indication that resources reserved for the UE's transmission will be, or could be, subject to conflict with a transmission from another UE. In this case, the UE may re-select new resources. The UE may receive the indication via PSFCH. The UE may use a mapping table that defines a mapping rule between PSSCH allocation (slots and sub-channels) and PSFCH resources. Using the mapping table, the UE (and the transmitter UE) can determine the PSSCH allocation (slot(s) and sub-channel(s) ) that the information in the PSFCH resource refers to. When more than one sub-channel is reserved in the PSSCH, multiple PSFCH resources may be used. The mapping table may be pre-defined, pre-configured at the UE, or configured by a network node.

The method 300 includes a step 306 of determining candidate resources by excluding occupied, reserved, and/or unmonitored resources. For example, the UE may exclude unmonitored slots from the selection window T (e.g., T=[T₁, T₂], where 0≤T₁=T^{SL}_{proc,1} ms, T^{SL}_{proc,1} is given in FIG. 4B, and T₂ may be set based on the remaining packet delay budget). The UE may fail to sense the unmonitored slots in the sensing window due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least X % of the total number of resources in the selection window. Otherwise, UE may increase the SL-RSRP exclusion threshold by, for example, 3 dB until at least X % resources are obtained, where X may be configured or preconfigured from {20, 35, 50} %.

The method 300 includes a step 308 of selecting resources among candidate resources. The selection may be a random selection.

For example, as shown in FIG. 4A, the UE may select resources among candidate resources in the selection window. The selected frequency resource can be used multiple times with a fixed time interval for SPS or only once for OST.

The method 300 includes a step 310 of checking resource availability based on re-evaluation and/or pre-emption of the selected resources. This step may be performed for the late-arriving packets (e.g., aperiodic packets) after resource selection and before the packet transmission.

The method 300 includes a step 312 of determining whether a resource reselection is needed. If it is determined that a resource reselection is needed, the method may iterate from the step 304. On the other hand, if it is determined that a resource reselection is not needed, the method may proceed with a step 314 of transmitting packets based on SPS or OST. The packets may be initial packets or retransmitted packets. The UE may also retransmit packets multiple times (e.g., HARQ retransmissions) with or without feedback from receiver UEs to improve reliability of the transmission.

Some embodiments of the present disclosure are directed to resource selection or reselection for co-channel coexistence of two or more sidelink communications (e.g., the sidelink communication described in relation to FIGS. 1-2 and the sidelink communication described in relations to FIG. 3-4B).

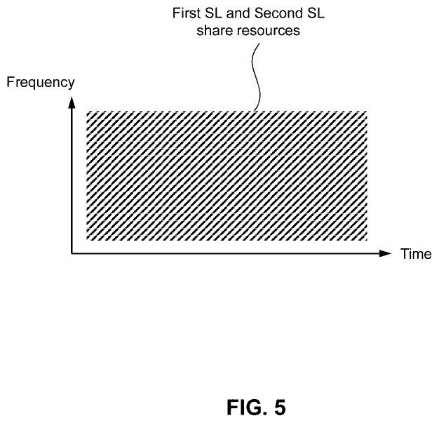

FIG. 5 is a schematic diagram illustrating dynamic co-channel coexistence of a first sidelink (SL) communication and a second sidelink (SL) communication, consistent with some embodiments of the present disclosure. In an embodiment, the first sidelink communication is NR sidelink communication and the second sidelink communication is LTE sidelink communication. As shown in FIG. 5, the first sidelink communication and the second sidelink communication share time and/or frequency resources. However, the methods described in this disclosure are not so limited. The methods described in this disclosure can be applied to any sidelink communications, for example, a future generation (6^{th} generation (6G), 7^{th} generation (7G), or any future generation) sidelink communications. Moreover, the methods described in this disclosure can also be applied to downlink/uplink communications between a base station and a UE.

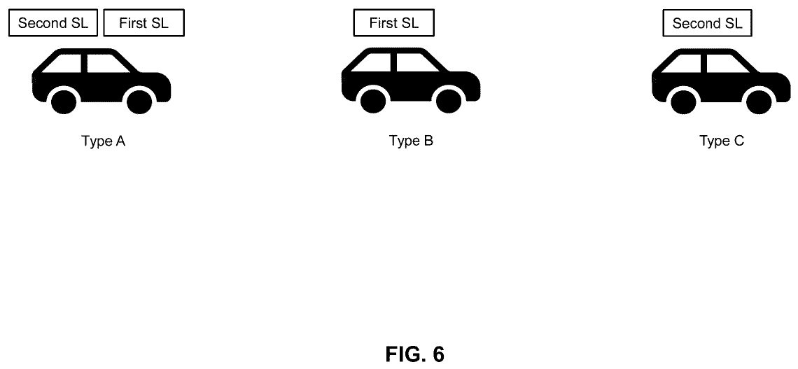

FIG. 6 is a schematic diagram illustrating device types for dynamic co-channel coexistence of a first sidelink (SL) communication and a second sidelink (SL) communication, consistent with some embodiments of the present disclosure.

Referring to FIG. 6, at least three types (Type A, Type B, and Type C) of devices are considered in this disclosure. A Type A device includes a module for the first sidelink communication and a module for the second sidelink communication. A Type B device only includes a module for the first sidelink communication. A Type C device only includes a module for the second sidelink communication. For example, in an embodiment, a Type A device includes both LTE SL and NR SL modules; a Type B device only includes an NR SL module; and a Type C device only includes an LTE SL module.

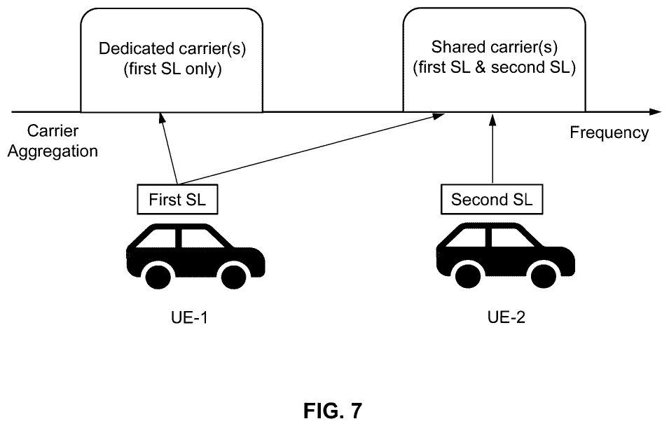

FIG. 7 is a schematic diagram illustrating an exemplary sidelink carrier aggregation using one or more sidelink carriers dedicated for a first sidelink (SL) communication only, and one or more sidelink carriers shared by the first sidelink communication and a second sidelink communication, consistent with some embodiments of the present disclosure. Referring to FIG. 7, a first UE (UE-1) in a first sidelink communication is able to use dedicated sidelink carriers that are dedicated for the first sidelink communication only, and shared sidelink carriers that are shared by the first sidelink communication and the second sidelink communication. In contrast, a second UE (UE-2) in the second sidelink communication can only use the shared sidelink carriers.

For example, in an embodiment, the first sidelink communication may be an NR sidelink communication and the second sidelink communication may be an LTE sidelink communication. The UE-1 is operated in a 5G NR sidelink communication. The UE-1 may be a Type A UE of FIG. 6 that can decode the resource reservation information of the LTE. The UE-1 can use both the dedicated sidelink carriers that are dedicated for NR SL only, and the shared sidelink carriers that are shared by the NR SL and the LTE SL. The NR SL and the LTE SL may share one or more sidelink carriers, for example, using dynamic resource sharing based on co-channel coexistence. The UE-1 may prefer to aggregate one or more carriers from the dedicated sidelink carriers and one or more carriers from the shared sidelink carriers, in order to achieve higher throughput and/or reliable communication. For example, to increase the throughput, multiple media access control protocol data units (MAC PDUs) may be transmitted on multiple sidelink carriers. To improve the reliability, packet data convergence protocol (PDCP) duplication may be supported, in which the same PDCP packet is transmitted on multiple sidelink carriers. On the other hand, the UE-2 in the LTE SL may be a Type C UE as shown in FIG. 6, and thus, is unable to decode or detect the resource reservation information of the UE-1. In this case, the use of the shared sidelink carriers by the UE-1 may insult in resource allocation that is unfair to UE-2, and/or cause channel congestion in the shared sidelink carriers. At least some embodiments of the present disclosure provide solutions to such issues.

At least some embodiments of the present disclosure ensure proper selection of sidelink carriers, where a UE considers dedicated sidelink carriers first, and then if additional sidelink carriers are desired, the UE tests for the suitability of sidelink carriers shared with other radio access technologies (RATs). The disclosed methods may improve the spectral efficiency. For example, at least some embodiments are directed to Tx carrier (re-)selection methods for 5G NR sidelink carrier aggregation using dedicated sidelink carriers and shared sidelink carriers shared with LTE SL without causing negative impact to the LTE SL in the shared sidelink carriers. While the examples in the present disclosure relate to NR SL and LTE SL, the application of the disclosed methods are not so limited. The methods described in this disclosure can be applied to any sidelink communications (or RATs), for example, a future generation (6^{th} generation (6G), 7^{th} generation (7G), or any future generation) sidelink communications. The methods described in this disclosure can also be applied to other systems, for example, carrier aggregation in a wireless local area network, or any other system that complies with other standards (e.g., the Institute of Electrical and Electronics Engineers (IEEE) standards).

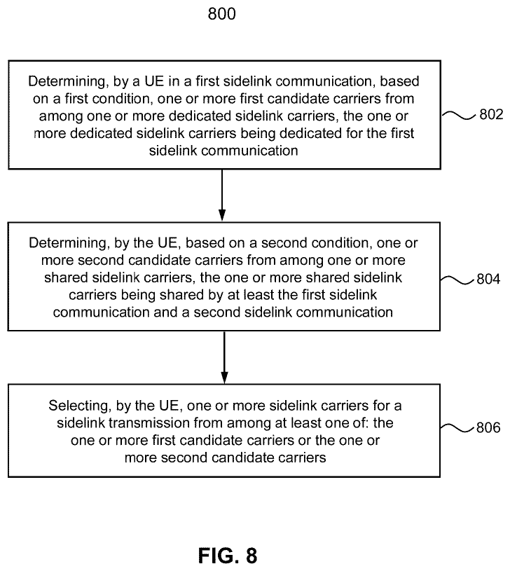

FIG. 8 is a flow chart illustrating a method 800 for carrier Selection or re-selection for sidelink carrier aggregation, consistent with some embodiments of the present disclosure. The method 800 may be performed by a UE in a sidelink communication, such as the UE-1 of FIG. 7.

The method 800 includes a step 802 of determining, by a UE in a first sidelink communication, based on a first condition, one or more first candidate carriers from among one or more dedicated sidelink carriers, the one or more dedicated sidelink carriers being dedicated for the first sidelink communication. For example, a UE, such as the UE-1 in FIG. 7, may determine one or more first candidate carriers from among one or more dedicated sidelink carriers for carrier aggregation. In an embodiment, the first sidelink communication is an NR sidelink communication and the one or more dedicated sidelink carriers are dedicated for the NR sidelink only. In some embodiments, the first condition may include at least one of: one or more channel busy ratios (CBRs) associated with the one or more dedicated sidelink carriers, or a number of unsuccessful receptions associated with the one or more dedicated sidelink carriers.

In some embodiments, in determining the one or more first candidate carriers among the one or more dedicated sidelink carriers, the UE may consider the one or more dedicated sidelink carriers as the one or more first candidate carriers in response to a determination that one or more CBRs associated with the one or more dedicated sidelink carriers measured in X₁ slots is below a first threshold, where X₁ is a natural number. The UE may measure the one or more CBRs associated with the one or more dedicated sidelink carriers in the X₁ slots, for example, in response to a triggering of a selection or re-selection of a transmission carrier. The first threshold may be configured by a network node or pre-configured at the UE. The first threshold may be a function of priority of the sidelink transmission.

In some embodiments, in determining the one or more first candidate carriers among the one or more dedicated sidelink carriers, the UE may consider the one or more dedicated sidelink carriers as the one or more first candidate carriers in response to a determination that a number of unreserved contiguous subchannels measured in X₁ slots is above a second threshold, where X₁ is a natural number. The UE may measure the number of unreserved contiguous subchannels in the X₁ slots, for example, in response to a triggering of a selection or re-selection of a transmission carrier. The second threshold may be configured by a network node or pre-configured at the UE.

In some embodiments, in determining the one or more first candidate carriers among the one or more dedicated sidelink carriers, the UE may consider the one or more dedicated sidelink carriers as the one or more first candidate carriers in response to a determination of that, for a unicast or a groupcast transmission, a number of unsuccessful receptions in X₁ slots on each of the one or more dedicated sidelink carriers is below a third threshold, where X₁ is a natural number. The UE may measure the number of unsuccessful receptions in the X₁ slots on each of the one or more dedicated sidelink carriers, for example, in response to a triggering of a selection or re-selection of a transmission carrier. The third threshold may be configured by a network node or pre-configured at the UE. The third threshold may be a function of CBR and a priority of the sidelink transmission. The number of unsuccessful receptions in the X₁ slots may be determined using a number of NACK feedbacks.

In some embodiments, the UE may receive, from a base station, the information about the number of unsuccessful receptions in the X₁ slots, when the UE is in coverage or operating in a first sidelink mode. In some embodiments, the UE may transmit, to the base station, a request for the information about the number of unsuccessful receptions in the X₁ slots, and in response to the request, receive the information about the number of unsuccessful receptions in the X₁ slots from the base station. In some embodiments, the UE may receive, from a second UE, the information about the number of unsuccessful receptions in the X₁ slots, in response to a request for the information about the number of unsuccessful receptions in the Xi slots transmitted to the second UE.

The method 800 includes a step 804 of determining, by the UE, based on a second condition, one or more second candidate carriers from among one or more shared sidelink carriers, the one or more shared sidelink carriers being shared by at least the first sidelink communication and a second sidelink communication. For example, in an embodiment, the first sidelink communication is an NR sidelink communication and the second sidelink communication is an LTE sidelink communication, and the one or more shared sidelink carriers are one or more carriers shared by the NR sidelink communication and the LTE sidelink communication. In some embodiments, the second condition may include at least one of: one or more CBRs associated with the shared sidelink carriers, a priority of the sidelink transmission, an amount of traffic in the first sidelink communication, an amount of traffic in the second sidelink communication, a number of the one or more first candidate carriers, or a number of the one or more second candidate carriers.

In some embodiments, in determining the one or more second candidate carriers among the one or more shared sidelink carriers, the UE may consider the one or more shared sidelink carriers as the one or more second candidate carriers in response to a determination that one or more CBRs associated with the one or more shared sidelink carriers measured in X₂ slots is below a fourth threshold, where X₂ is a natural number. The fourth threshold may be configured by a network node or pre-configured at the UE.

In some embodiments, in determining the one or more second candidate carriers among the one or more shared sidelink carriers, the UE may consider the one or more shared sidelink carriers as the one or more second candidate carriers in response to a determination that a number of unreserved contiguous subchannels measured in the X₂ slots is above a fifth threshold, where X₂ is a natural number. The fifth threshold may be configured by a network node or pre-configured at the UE.

In some embodiments, in determining the one or more second candidate carriers among the one or more shared sidelink carriers, the UE may consider the one or more shared sidelink carriers as the one or more second candidate carriers in response to a determination that a ratio of a traffic amount in the first sidelink communication to a traffic amount in the second sidelink communication in the X₂ slots is below a sixth threshold, where X₂ is a natural number. The sixth threshold may be configured by a network node or pre-configured at the UE. The sixth threshold may be a function of a CBR and a priority of the sidelink transmission.

In an embodiment, the UE may include a module for the first sidelink communication and a module for the second sidelink communication. For example, the UE may be a Type A UE as shown in FIG. 6, and include an NR module and an LTE module. In determining the one or more second candidate carriers, the UE may consider the one or more shared sidelink carriers as the one or more second candidate carriers, in response to a determination that the ratio of a traffic amount in the first sidelink communication to a traffic amount in the second sidelink communication in the X₂ slots is below a sixth threshold. In this embodiment, the UE may determine the traffic amount in the first sidelink communication and the traffic amount in the second sidelink communication based on decoding of at least one of: the PSCCH included in one or more packets received in the first sidelink communication, the PSCCH included in one or more packets received in the second sidelink communication, the PSSCH included in the one or more packets received in the first sidelink communication, or the PSSCH included in the one or more packets received in the second sidelink communication.

In some embodiments, the UE may further measure a first reference signal received power (RSRP) for the one or more packets received in the first sidelink communication. The UE may take into account the one or more packets received in the first sidelink communication for determining the traffic amount in the first sidelink communication if the first RSPR is greater than a first RSRP threshold. The first RSRP threshold may be configured by a network node or pre-configured at the UE.

The UE may also measure a second RSRP for the one or more packets received in the second sidelink communication. The UE may take into account the one or more packets received in the second sidelink communication for determining the traffic amount in the second sidelink communication if the second RSPR is greater than a second RSRP threshold. The second RSRP threshold may be configured by a network node or pre-configured at the UE.

In some embodiments, each of the one or more packets received in the first sidelink communication has a priority. In this case, the UE may take into account at least one packet among the one or more packets received in the first sidelink communication for determining the traffic amount in the first sidelink communication if the at least one packet has a first priority higher (more important) than a first priority threshold. The first priority threshold may be configured by a network node or pre-configured at the UE.

In some embodiments, each of the one or more packets received in the second sidelink communication has a priority. In this case, the UE may also take into account at least one packet among the one or more packets received in the second sidelink communication for determining the traffic amount in the second sidelink communication if the at least one packet has a second priority higher than a second priority threshold. The second priority threshold may be configured by a network node or pre-configured at the UE.

In an embodiment, the UE may include a module for the first sidelink communication. In determining the one or more second candidate carriers, the UE may consider the one or more shared carriers as the one or more second candidate carriers, in response to a determination that the ratio of the traffic amount in the first sidelink communication to the traffic amount in the second sidelink communication in the X₂ slots is below a sixth threshold. In this embodiment, the UE may determine the traffic amount in the first sidelink communication based on decoding of at least one of: PSCCH included in one or more packets received in the first sidelink communication, or PSSCH included in the one or more packets received in the first sidelink communication. The UE may also determine the traffic amount in second sidelink communication based on a difference between a power spectrum density for the first sidelink communication and a power spectrum density for the second sidelink communication.

In some embodiments, in determining the one or more second candidate carriers, the UE may consider the one or more shared carriers as the one or more second candidate carriers, in response to a determination that the ratio of the traffic amount in the first sidelink communication to the traffic amount in the second sidelink communication in the X₂ slots is below a sixth threshold. The UE may obtain, from a base station, the ratio of the traffic amount for the first sidelink communication to the traffic amount for the second sidelink communication in the X₂ slots.

The method 800 includes a step 806 of selecting, by the UE, one or more sidelink carriers for a sidelink transmission from among at least one of: the one or more first candidate carriers or the one or more second candidate carriers. In some embodiments, the UE may select the one or more sidelink carriers among at least one of the one or more first candidate carriers or the one or more second candidate carriers, based on capability of the UE. In some embodiments, in selecting the one or more sidelink carriers for the sidelink transmission, the UE may further consider an increasing or decreasing order of CBRs. For example, the UE may select one or more sidelink carriers based on CBR with increasing order of CBR from a lowest CBR. In some embodiments, the UE may sort the carriers using any of the metrics for identifying a carrier as a candidate carrier, for example, the number of non-reserved/free contiguous subchannels or the number of unsuccessful receptions.

In some embodiments, the UE may randomly select the one or more sidelink carriers for the sidelink transmission among at least one of the one or more first candidate carriers or the one or more second candidate carriers. For example, the selection of carriers may be done randomly and uniformly among a subset of candidate carriers where the subset is formed based on one or more criteria (e.g., CBR and the number of non-reserved/free contiguous subchannels), for example, by excluding candidate carriers with lowest and highest CBR.

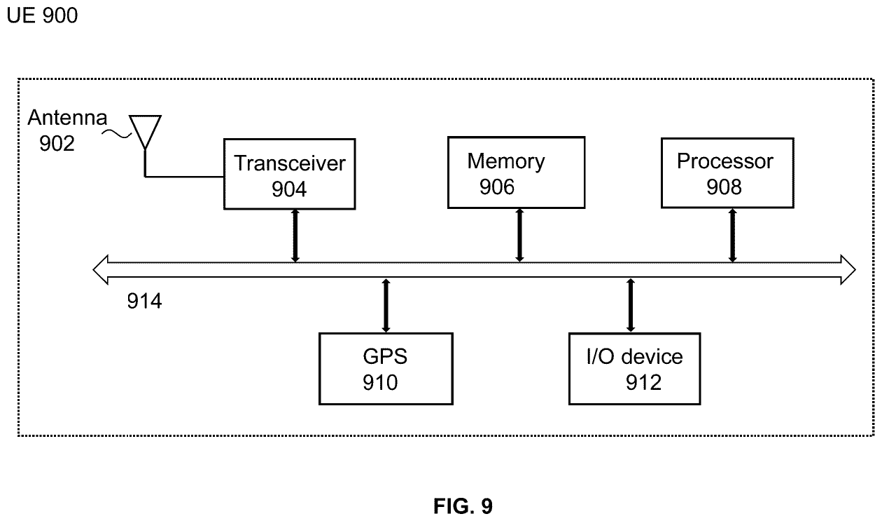

FIG. 9 is a block diagram of a UE 900, consistent with some embodiments of the present disclosure. The UE 900 can be a Type A, Type B, Type C, or any other type of UE. UE 900 may be mounted in a moving vehicle or in a fixed position. UE 900 may take any form, including but not limited to, a vehicle, a component mounted in a vehicle, a road-side unit, a laptop computer, a wireless terminal including a mobile phone, a wireless handheld device, or wireless personal device, or any other form. Referring to FIG. 9, the UE 900 may include antenna 902 that may be used for transmission or reception of electromagnetic signals to/from a base station or other UEs. The Antenna 902 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 902 may include multiple (e.g., tens or hundreds) antenna elements and may enable multi-antenna functions such as beamforming. In some embodiments, the antenna 902 is a single antenna.

The UE 900 may include a transceiver 904 that is coupled to the antenna 902. The transceiver 904 may be a wireless transceiver at the UE 900 and may communicate bi-directionally with a base station or other UEs. For example, the transceiver 904 may receive/transmit wireless signals from/to a base station via downlink/uplink communication. The transceiver 904 may also receive/transmit wireless signals from/to another UE or road side unit via sidelink communication. The transceiver 904 may include a modem to modulate the packets and provide the modulated packets to the antenna 902 for transmission, and to demodulate packets received from the antenna 902.

The UE 900 may include a memory 906. The memory 906 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 906 may store information related to identities of UE 900 and the signals and/or data received by antenna 902. The memory 906 may also store post-processing signals and/or data. The memory 906 may also store computer-readable program instructions, mathematical models, and algorithms that are used in signal processing in transceiver 904 and computations in processor 908. The memory 906 may further store computer-readable program instructions for execution by processor 908 to operate UE 900 to perform various functions described in this disclosure. In some examples, the memory 906 may include a basic input/output system (BIOS) which may control basic hardware or software operation such as the interaction with peripheral components or devices. In some embodiments, the UE 900 is a Type A UE and the memory 906 includes both LTE SL and NR SL modules. In some embodiments, the UE 900 is a Type B UE and the memory 906 includes an NR SL module only. In some embodiments, the UE 900 is a Type C UE and the memory 906 includes an LTE SL module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 900 may include a processor 908 that may include a hardware device with processing capabilities. The processor 908 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 908 may be implemented using a combination of devices (e.g., a combination of a DSP and a microprocessor, multiple microprocessors, one or more microprocessors in conjunction with a DSP core, or any other such configuration). The processor 908 may receive, from transceiver 904, downlink signals or sidelink signals and further process the signals. The processor 908 may also receive, from transceiver 904, data packets and further process the packets. In some embodiments, the processor 908 may be configured to operate a memory using a memory controller. In some embodiments, a memory controller may be integrated into the processor 908. The processor 908 may be configured to execute computer-readable instructions stored in a memory (e.g., the memory 906) to cause the UE 900 to perform various functions.

The UE 900 may include a global positioning system (GPS) 910. The GPS 910 may be used for enabling location-based services or other services based on a geographical position of the UE 900 and/or synchronization among UEs. The GPS 910 may receive global navigation satellite systems (GNSS) signals from a single satellite or a plurality of satellite signals via the antenna 902 and provide a geographical position of the UE 900 (e.g., coordinates of the UE 900). In some embodiments, the GPS 910 is omitted.

The UE 900 may include an input/output (I/O) device 912 that may be used to communicate a result of signal processing and computation to a user or another device. The I/O device 912 may include a user interface including a display and an input device to transmit a user command to processor 908. The display may be configured to display a status of signal reception at the UE 900, the data stored at memory 906, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 900 may further include a machine interface 914, such as an electrical bus that connects the transceiver 904, the memory 906, the processor 908, the GPS 910, and the I/O device 912.

In some embodiments, the UE 900 may be configured or programmed to perform carrier selection or reselection for sidelink carrier aggregation using one or more dedicated sidelink carriers dedicated for a first sidelink communication, and one or more shared sidelink carriers shared by the first sidelink communication and a second sidelink communication. The processor 908 may be configured or programmed to execute the instructions stored in the memory 906 to determine, based on a first condition, one or more first candidate carriers from among one or more dedicated sidelink carriers, the one or more dedicated sidelink carriers being dedicated for the first sidelink communication; determine, based on a second condition, one or more second candidate carriers from among one or more shared sidelink carriers, the one or more shared sidelink carriers being shared by at least the first sidelink communication and a second sidelink communication; and select one or more sidelink carriers for a sidelink transmission from among at least one of: the one or more first candidate carriers or the one or more second candidate carriers.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1. A method for carrier selection or re-selection for sidelink carrier aggregation, the method comprising: determining, by a user equipment (UE) in a first sidelink communication, based on a first condition, one or more first candidate carriers from among one or more dedicated sidelink carriers, the one or more dedicated sidelink carriers being dedicated for the first sidelink communication; determining, by the UE, based on a second condition, one or more second candidate carriers from among one or more shared sidelink carriers, the one or more shared sidelink carriers being shared by at least the first sidelink communication and a second sidelink communication; and Selecting, by the UE, one or more sidelink carriers for a sidelink transmission from among at least one of: the one or more first candidate carriers or the one or more second candidate carriers.

Clause 2. The method of Clause 1, wherein the first condition comprises at least one of: one or more channel busy ratios (CBRs) associated with the one or more dedicated sidelink carriers, or a number of unsuccessful receptions associated with the one or more dedicated sidelink carriers.

Clause 3. The method of Clause 1, wherein the second condition comprises at least one of: one or more CBRs associated with the shared sidelink carriers, a priority of the sidelink transmission, an amount of traffic in the first sidelink communication, an amount of traffic in the second sidelink communication, a number of the one or more first candidate carriers, or a number of the one or more second candidate carriers.

Clause 4. The method of Clause 1, wherein the first sidelink communication is a new radio (NR) sidelink communication and the second sidelink communication is a long-term evolution (LTE) sidelink communication.

Clause 5. The method of Clause 1, wherein determining the one or more first candidate carriers among the one or more dedicated sidelink carriers further comprises:
considering the one or more sidelink dedicated carriers as the one or more first candidate carriers in response to a determination of at least one of:
one or more CBRs associated with the one or more dedicated sidelink carriers measured in Xi slots being below a first threshold, the first threshold being configured or pre-configured, where X₁ is a natural number;
a number of unreserved contiguous subchannels measured in Xi slots being above a second threshold, the second threshold being configured or pre-configured; or
for a unicast or a groupcast transmission, a number of unsuccessful receptions in X₁ slots on each of the one or more dedicated sidelink carriers being below a third threshold, the third threshold being configured or pre-configured.

Clause 6. The method of Clause 5, wherein the first threshold is a function of priority of the sidelink transmission.

Clause 7. The method of Clause 5, wherein the third threshold is a function of CBR and a priority of the sidelink transmission.

Clause 8. The method of Clause 5, wherein the number of unsuccessful receptions in the X₁ slots is determined using a number of negative acknowledgement (NACK) feedbacks.

Clause 9. The method of Clause 5, wherein information about the number of unsuccessful receptions in the X₁ slots is received by the UE from a base station, when the UE is in coverage or operating in a first sidelink mode.

Clause 10. The method of Clause 9, wherein the information about the number of unsuccessful receptions in the X₁ slots is received by the UE from the base station, in response to a request for the information about the number of unsuccessful receptions in the X₁ slots transmitted to the base station.

Clause 11. The method of Clause 5, wherein the UE is a first UE, and wherein information about the number of unsuccessful receptions in the X₁ slots is received by the first UE from a second UE, in response to a request for the information about the number of unsuccessful receptions in the X₁ slots transmitted to the second UE.

Clause 12. The method of Clause 5, further comprising: in response to a triggering of a selection or re-selection of a transmission carrier, measuring at least one of:

(1) the one or more CBRs associated with the one or more dedicated sidelink carriers in the X₁ slots;
(2) the number of unreserved contiguous subchannels in the X₁ slots; or
(3) the number of unsuccessful receptions in the X₁ slots on each of the one or more dedicated sidelink carriers, wherein the X₁ slots are configured or pre-configured.

Clause 13. The method of Clause 1, wherein determining the one or more second candidate carriers among the one or more shared sidelink carriers further comprises: considering the one or more shared sidelink carriers as the one or more second candidate carriers in response to a determination of at least one of:
(1) one or more CBRs associated with the one or more shared sidelink carriers measured in X₂ slots being below a fourth threshold, the fourth threshold being configured or pre-configured, where X₂ is a natural number;
(2) a number of unreserved contiguous subchannels measured in the X₂ slots being above a fifth threshold, the fifth threshold being configured or pre-configured; or
(3) a ratio of a traffic amount in the first sidelink communication to a traffic amount in the second sidelink communication in the X₂ slots being below a sixth threshold, the sixth threshold being configured or pre-configured.

Clause 14. The method of Clause 13, wherein the sixth threshold is a function of a CBR and a priority of the sidelink transmission.

Clause 15. The method of Clause 13, wherein the UE includes a module for the first sidelink communication and a module for the second sidelink communication, and determining the one or more second candidate carriers comprises considering the one or more shared sidelink carriers as the one or more second candidate carriers in response to a determination of the ratio of a traffic amount in the first sidelink communication to a traffic amount in the second sidelink communication in the X₂ slots is below the sixth threshold, and the method further comprises:
determining, by the UE, the traffic amount in the first sidelink communication and the traffic amount in the second sidelink communication based on decoding of at least one of: physical sidelink control channel (PSCCH) included in one or more packets received in the first sidelink communication, PSCCH included in one or more packets received in the second sidelink communication, physical sidelink shared channel (PSSCH) included in the one or more packets received in the first sidelink communication, or PSSCH included in the one or more packets received in the second sidelink communication.

Clause 16. The method of Clause 15, further comprising:
measuring a first reference signal received power (RSRP) for the one or more packets received in the first sidelink communication;
measuring a second RSRP for the one or more packets received in the second sidelink communication;
taking into account the one or more packets received in the first sidelink communication for determining the traffic amount in the first sidelink communication if the first RSPR is greater than a first RSRP threshold; and
taking into account the one or more packets received in the second sidelink communication for determining the traffic amount in the second sidelink communication if the second RSPR is greater than a second RSRP threshold,
wherein the first RSRP threshold and the second RSRP threshold are configured or pre-configured.

Clause 17. The method of Clause 15, wherein each of the one or more packets received in the first sidelink communication and each of the one or more packets received in the second sidelink communication has a priority, and the method further comprises:
taking into account at least one packet among the one or more packets received in the first sidelink communication for determining the traffic amount in the first sidelink communication if the at least one packet has a first priority higher than a first priority threshold; and
taking into account at least one packet among the one or more packets received in the second sidelink communication for determining the traffic amount in the second sidelink communication if the at least one packet has a second priority higher than a second priority threshold,
wherein the first priority threshold and the second priority threshold are configured or pre-configured.

Clause 18. The method of Clause 13, wherein the UE includes a module for the first sidelink communication, and determining the one or more second candidate carriers comprises considering the one or more shared carriers as the one or more second candidate carriers, in response to a determination that the ratio of the traffic amount in the first sidelink communication to the traffic amount in the second sidelink communication in the X₂ slots is below the sixth threshold, and the method further comprises:
determining, by the UE, the traffic amount in the first sidelink communication based on decoding of at least one of: PSCCH included in one or more packets received in the first sidelink communication, or PSSCH included in the one or more packets received in the first sidelink communication; and
determining, by the UE, the traffic amount in the second sidelink communication based on a difference between a power spectrum density for the first sidelink communication and a power spectrum density for the second sidelink communication.

Clause 19. The method of Clause 13, wherein determining the one or more second candidate carriers comprises: considering the one or more shared carriers as the one or more second candidate carriers, in response to a determination that the ratio of the traffic amount in the first sidelink communication to the traffic amount in the second sidelink communication in the X₂ slots is below the sixth threshold, and wherein the ratio of the traffic amount for the first sidelink communication to the traffic amount for the second sidelink communication in the X₂ slots is obtained from a base station.

Clause 20. The method of Clause 1, wherein selecting the one or more sidelink carriers for the sidelink transmission comprises: selecting, by the UE, the one or more sidelink carriers among at least one of: the one or more first candidate carriers or the one or more second candidate carriers, based on capability of the UE.

Clause 21. The method of Clause 20, wherein selecting the one or more sidelink carriers for the sidelink transmission is further based on an increasing or decreasing order of CBRs.

Clause 22. The method of Clause 1, wherein selecting the one or more sidelink carriers for the sidelink transmission is performed randomly among at least one of: the one or more first candidate carriers or the one or more second candidate carriers.

Clause 23. A user equipment (UE) for a first sidelink communications, the UE comprising:
a memory storing an instruction; and
a processor configured to execute the instruction stored in the memory to:
determine, based on a first condition, one or more first candidate carriers from among one or more dedicated sidelink carriers, the one or more dedicated sidelink carriers being dedicated for the first sidelink communication;
determine, based on a second condition, one or more second candidate carriers from among one or more shared sidelink carriers, the one or more shared sidelink carriers being shared by at least the first sidelink communication and a second sidelink communication; and
select one or more sidelink carriers for a sidelink transmission from among at least one of: the one or more first candidate carriers or the one or more second candidate carriers.

Clause 24. The UE of Clause 23, wherein the first condition comprises at least one of: one or more channel busy ratios (CBRs) associated with the one or more dedicated sidelink carriers, or a number of unsuccessful receptions associated with the one or more dedicated sidelink carriers.

Clause 25. The UE of Clause 23, wherein the second condition comprises at least one of: one or more CBRs associated with the shared sidelink carriers, a priority of the sidelink transmission, an amount of traffic in the first sidelink communication, an amount of traffic in the second sidelink communication, a number of the one or more first candidate carriers, or a number of the one or more second candidate carriers.

Clause 26. The UE of Clause 23, wherein the first sidelink communication is a new radio (NR) sidelink communication and the second sidelink communication is a long-term evolution (LTE) sidelink communication.

Clause 27. The UE of Clause 23, wherein determining the one or more first candidate carriers among the one or more dedicated sidelink carriers further comprises:
considering the one or more dedicated sidelink carriers as the one or more first candidate carriers in response to a determination of at least one of:
(1) one or more CBRs associated with the one or more dedicated sidelink carriers measured in X₁ slots being below a first threshold, the first threshold being configured or pre-configured, where X₁ is a natural number;
(2) a number of unreserved contiguous subchannels measured in X₁ slots being above a second threshold, the second threshold being configured or pre-configured; or
(3) for a unicast or a groupcast transmission, a number of unsuccessful receptions in X₁ slots on each of the one or more dedicated sidelink carriers being below a third threshold, the third threshold being configured or pre-configured.

Clause 28. The UE of Clause 27, wherein the first threshold is a function of priority of the sidelink transmission.

Clause 29. The UE of Clause 27, wherein the third threshold is a function of CBR and a priority of the sidelink transmission.

Clause 30. The UE of Clause 27, wherein the number of unsuccessful receptions in the X₁ slots is determined using a number of negative acknowledgement (NACK) feedbacks.

Clause 31. The UE of Clause 27, wherein information about the number of unsuccessful receptions in the X₁ slots is received by the UE from a base station, when the UE is in coverage or operating in a first sidelink mode.

Clause 32. The UE of Clause 31, wherein the information about the number of unsuccessful receptions in the X₁ slots is received by the UE from the base station, in response to a request for the information about the number of unsuccessful receptions in the X₁ slots transmitted to the base station.

Clause 33. The UE of Clause 27, wherein the UE is a first UE, and wherein the information about the number of unsuccessful receptions in the X₁ slots is received by the first UE from a second UE, in response to a request for the information about the number of unsuccessful receptions in the X₁ slots transmitted to the second UE.

Clause 34. The UE of Clause 27, wherein the processor is further configured to execute the instruction stored in the memory to:
measure, in response to a triggering of a selection or re-selection of a transmission carrier, at least one of:
(1) the one or more CBRs associated with the one or more dedicated sidelink carriers in the X₁ slots;
(2) the number of unreserved contiguous subchannels in the X₁ slots; or
(3) the number of unsuccessful receptions in the X₁ slots on each of the one or more dedicated sidelink carriers,
wherein the X₁ slots are configured or pre-configured.

Clause 35. The UE of Clause 23, wherein, in determining the one or more second candidate carriers among the one or more shared sidelink carriers, the processor is further configured to execute the instruction stored in the memory to: consider the one or more shared sidelink carriers as the one or more second candidate carriers in response to a determination of at least one of:
(1) one or more CBRs associated with the one or more shared sidelink carriers measured in X₂ slots being below a fourth threshold, the fourth threshold being configured or pre-configured, where X₂ is a natural number;
(2) a number of unreserved contiguous subchannels measured in the X₂ slots being above a fifth threshold, the fifth threshold being configured or pre-configured; or
(3) a ratio of a traffic amount in the first sidelink communication to a traffic amount in the second sidelink communication in the X₂ slots being below a sixth threshold, the sixth threshold being configured or pre-configured.

Clause 36. The UE of Clause 35, wherein the sixth threshold is a function of a CBR and a priority of the sidelink transmission.

Clause 37. The UE of Clause 35, wherein the UE includes a module for the first sidelink communication and a module for the second sidelink communication, and determining the one or more second candidate carriers comprises considering the one or more shared sidelink carriers as the one or more second candidate carriers in response to a determination of the ratio of a traffic amount in the first sidelink communication to a traffic amount in the second sidelink communication in the X₂ slots is below the sixth threshold, and wherein the processor is further configured to execute the instruction stored in the memory to:
determine the traffic amount in the first sidelink communication and the traffic amount in the second sidelink communication based on decoding of at least one of: physical sidelink control channel (PSCCH) included in one or more packets received in the first sidelink communication, PSCCH included in one or more packets received in the second sidelink communication, physical sidelink shared channel (PSSCH) included in the one or more packets received in the first sidelink communication, or PSSCH included in the one or more packets received in the second sidelink communication.

Clause 38. The UE of Clause 37, wherein the processor is further configured to execute the instruction stored in the memory to:
measure a first reference signal received power (RSRP) for the one or more packets received in the first sidelink communication;
measure a second RSRP for the one or more packets received in the second sidelink communication;
take into account the one or more packets received in the first sidelink communication for determining the traffic amount in the first sidelink communication if the first RSPR is greater than a first RSRP threshold; and
take into account the one or more packets received in the second sidelink communication for determining the traffic amount in the second sidelink communication if the second RSPR is greater than a second RSRP threshold,
wherein the first RSRP threshold and the second RSRP threshold are configured or pre-configured.

Clause 39. The UE of Clause 37, wherein each of the one or more packets received in the first sidelink communication and each of the one or more packets received in the second sidelink communication has a priority, and wherein the processor is further configured to execute the instruction stored in the memory to:
take into account at least one packet among the one or more packets received in the first sidelink communication for determining the traffic amount in the first sidelink communication if the at least one packet has a first priority higher than a first priority threshold; and
take into account at least one packet among the one or more packets received in the second sidelink communication for determining the traffic amount in the second sidelink communication if the at least one packet has a second priority higher than a second priority threshold,
wherein the first priority threshold and the second priority threshold are configured or pre-configured.

Clause 40. The UE of Clause 35, wherein the UE includes a module for the first sidelink communication, and determining the one or more second candidate carriers comprises considering the one or more shared carriers as the one or more second candidate carriers, in response to a determination that the ratio of the traffic amount in the first sidelink communication to the traffic amount in the second sidelink communication in the X₂ slots is below the sixth threshold, and wherein the processor is further configured to execute the instruction stored in the memory to:
determine the traffic amount in the first sidelink communication based on decoding of at least one of: PSCCH included in one or more packets received in the first sidelink communication, or PSSCH included in the one or more packets received in the first sidelink communication; and
determine the traffic amount in the second sidelink communication based on a difference between a power spectrum density for the first sidelink communication and a power spectrum density for the second sidelink communication.

Clause 41. The UE of Clause 35, wherein, in determining the one or more second candidate carriers, the processor is further configured to execute the instruction stored in the memory to:
consider the one or more shared carriers as the one or more second candidate carriers, in response to a determination that the ratio of the traffic amount in the first sidelink communication to the traffic amount in the second sidelink communication in the X₂ slots is below the sixth threshold, and wherein the ratio of the traffic amount for the first sidelink communication to the traffic amount for the second sidelink communication in the X₂ slots is obtained from a base station.

Clause 42. The UE of Clause 23, wherein, in selecting the one or more sidelink carriers for the sidelink transmission, the processor is further configured to execute the instruction stored in the memory to: select the one or more sidelink carriers among at least one of: the one or more first candidate carriers or the one or more second candidate carriers, based on capability of the UE.

Clause 43. The UE of Clause 42, wherein selecting the one or more sidelink carriers for the sidelink transmission is further based on an increasing or decreasing order of CBRs.

Clause 44. The UE of Clause 23, wherein selecting the one or more sidelink carriers for the sidelink transmission is performed randomly among at least one of: the one or more first candidate carriers or the one or more second candidate carriers.

Clause 45. A non-transitory computer-readable medium storing instructions that are executable by one or more processors of a user equipment (UE) for a first sidelink communication to perform a method, the method comprising:
determining, based on a first condition, one or more first candidate carriers from among one or more dedicated sidelink carriers, the one or more dedicated sidelink carriers being dedicated for the first sidelink communication;
determining, based on a second condition, one or more second candidate carriers from among one or more shared sidelink carriers, the one or more shared sidelink carriers being shared by at least the first sidelink communication and a second sidelink communication; and
selecting one or more sidelink carriers for a sidelink transmission from among at least one of: the one or more first candidate carriers or the one or more second candidate carriers.

1. A method for carrier selection or re-selection for sidelink carrier aggregation, the method comprising:
determining, by a user equipment (UE) in a first sidelink communication, based on a first condition, one or more first candidate carriers from among one or more dedicated sidelink carriers, the one or more dedicated sidelink carriers being dedicated for the first sidelink communication;
determining, by the UE, based on a second condition, one or more second candidate carriers from among one or more shared sidelink carriers, the one or more shared sidelink carriers being shared by at least the first sidelink communication and a second sidelink communication; and
selecting, by the UE, one or more sidelink carriers for a sidelink transmission from among at least one of: the one or more first candidate carriers or the one or more second candidate carriers.

2. The method of claim 1, wherein the first condition comprises at least one of: one or more channel busy ratios (CBRs) associated with the one or more dedicated sidelink carriers, or a number of unsuccessful receptions associated with the one or more dedicated sidelink carriers.

3. The method of claim 1, wherein the second condition comprises at least one of: one or more CBRs associated with the shared sidelink carriers, a priority of the sidelink transmission, an amount of traffic in the first sidelink communication, an amount of traffic in the second sidelink communication, a number of the one or more first candidate carriers, or a number of the one or more second candidate carriers.

4. The method of claim 1, wherein the first sidelink communication is a new radio (NR) sidelink communication and the second sidelink communication is a long-term evolution (LTE) sidelink communication.

5. The method of claim 1, wherein determining the one or more first candidate carriers among the one or more dedicated sidelink carriers further comprises:
considering the one or more dedicated sidelink carriers as the one or more first candidate carriers in response to a determination of at least one of:
one or more CBRs associated with the one or more dedicated sidelink carriers measured in X₁ slots being below a first threshold, the first threshold being configured or pre-configured, where X₁ is a natural number;
a number of unreserved contiguous subchannels measured in X₁ slots being above a second threshold, the second threshold being configured or pre-configured; or for a unicast or a groupcast transmission, a number of unsuccessful receptions in X₁ slots on each of the one or more dedicated sidelink carriers being below a third threshold, the third threshold being configured or pre-configured.

6. The method of claim 5, wherein the first threshold is a function of priority of the sidelink transmission.

7. The method of claim 5, wherein the third threshold is a function of CBR and a priority of the sidelink transmission.

8. The method of claim 5, wherein the number of unsuccessful receptions in the X₁ slots is determined using a number of negative acknowledgement (NACK) feedbacks.

9. The method of claim 5, wherein information about the number of unsuccessful receptions in the X₁ slots is received by the UE from a base station, when the UE is in coverage or operating in a first sidelink mode.

10. The method of claim 9, wherein the information about the number of unsuccessful receptions in the X₁ slots is received by the UE from the base station, in response to a request for the information about the number of unsuccessful receptions in the X₁ slots transmitted to the base station.

11. The method of claim 5, wherein the UE is a first UE, and wherein information about the number of unsuccessful receptions in the X₁ slots is received by the first UE from a second UE, in response to a request for the information about the number of unsuccessful receptions in the X₁ slots transmitted to the second UE.

12. The method of claim 5, further comprising:
in response to a triggering of a selection or re-selection of a transmission carrier, measuring at least one of:
(1) the one or more CBRs associated with the one or more dedicated sidelink carriers in the X₁ slots;
(2) the number of unreserved contiguous subchannels in the X₁ slots; or
(3) the number of unsuccessful receptions in the X₁ slots on each of the one or more dedicated sidelink carriers,
wherein the X₁ slots are configured or pre-configured.

13. The method of claim 1, wherein determining the one or more second candidate carriers among the one or more shared sidelink carriers further comprises:
considering the one or more shared sidelink carriers as the one or more second candidate carriers in response to a determination of at least one of:
(1) one or more CBRs associated with the one or more shared sidelink carriers measured in X₂ slots being below a fourth threshold, the fourth threshold being configured or pre-configured, where X₂ is a natural number;
(2) a number of unreserved contiguous subchannels measured in the X₂ slots being above a fifth threshold, the fifth threshold being configured or pre-configured; or
(3) a ratio of a traffic amount in the first sidelink communication to a traffic amount in the second sidelink communication in the X₂ slots being below a sixth threshold, the sixth threshold being configured or pre-configured.

14. The method of claim 13, wherein the sixth threshold is a function of a CBR and a priority of the sidelink transmission.

15. The method of claim 13, wherein the UE includes a module for the first sidelink communication and a module for the second sidelink communication, and determining the one or more second candidate carriers comprises considering the one or more shared sidelink carriers as the one or more second candidate carriers in response to a determination of the ratio of a traffic amount in the first sidelink communication to a traffic amount in the second sidelink communication in the X₂ slots is below the sixth threshold, and the method further comprises:
determining, by the UE, the traffic amount in the first sidelink communication and the traffic amount in the second sidelink communication based on decoding of at least one of: physical sidelink control channel (PSCCH) included in one or more packets received in the first sidelink communication, PSCCH included in one or more packets received in the second sidelink communication, physical sidelink shared channel (PSSCH) included in the one or more packets received in the first sidelink communication, or PSSCH included in the one or more packets received in the second sidelink communication.

16. The method of claim 15, further comprising:
measuring a first reference signal received power (RSRP) for the one or more packets received in the first sidelink communication;
measuring a second RSRP for the one or more packets received in the second sidelink communication;
taking into account the one or more packets received in the first sidelink communication for determining the traffic amount in the first sidelink communication if the first RSPR is greater than a first RSRP threshold; and
taking into account the one or more packets received in the second sidelink communication for determining the traffic amount in the second sidelink communication if the second RSPR is greater than a second RSRP threshold,
wherein the first RSRP threshold and the second RSRP threshold are configured or pre-configured.

17. The method of claim 15, wherein each of the one or more packets received in the first sidelink communication and each of the one or more packets received in the second sidelink communication has a priority, and the method further comprises:
taking into account at least one packet among the one or more packets received in the first sidelink communication for determining the traffic amount in the first sidelink communication if the at least one packet has a first priority higher than a first priority threshold; and
taking into account at least one packet among the one or more packets received in the second sidelink communication for determining the traffic amount in the second sidelink communication if the at least one packet has a second priority higher than a second priority threshold,
wherein the first priority threshold and the second priority threshold are configured or pre-configured.

18. The method of claim 13, wherein the UE includes a module for the first sidelink communication, and determining the one or more second candidate carriers comprises considering the one or more shared carriers as the one or more second candidate carriers, in response to a determination that the ratio of the traffic amount in the first sidelink communication to the traffic amount in the second sidelink communication in the X₂ slots is below the sixth threshold, and the method further comprises:
determining, by the UE, the traffic amount in the first sidelink communication based on decoding of at least one of: PSCCH included in one or more packets received in the first sidelink communication, or PSSCH included in the one or more packets received in the first sidelink communication; and
determining, by the UE, the traffic amount in the second sidelink communication based on a difference between a power spectrum density for the first sidelink communication and a power spectrum density for the second sidelink communication.

19. The method of claim 13, wherein determining the one or more second candidate carriers comprises: considering the one or more shared carriers as the one or more second candidate carriers, in response to a determination that the ratio of the traffic amount in the first sidelink communication to the traffic amount in the second sidelink communication in the X₂ slots is below the sixth threshold, and wherein the ratio of the traffic amount for the first sidelink communication to the traffic amount for the second sidelink communication in the X₂ slots is obtained from a base station.

20. A user equipment (UE) for a first sidelink communications, the UE comprising:
a memory storing an instruction; and
a processor configured to execute the instruction stored in the memory to:
determine, based on a first condition, one or more first candidate carriers from among one or more dedicated sidelink carriers, the one or more dedicated sidelink carriers being dedicated for the first sidelink communication;
determine, based on a second condition, one or more second candidate carriers from among one or more shared sidelink carriers, the one or more shared sidelink carriers being shared by at least the first sidelink communication and a second sidelink communication; and
select one or more sidelink carriers for a sidelink transmission from among at least one of: the one or more first candidate carriers or the one or more second candidate carriers.
